(19) United States
(12) Patent Application Publication
(10) Pub. No.: US 2024/0311998 A1
(43) Pub. Date: Sep. 19, 2024

(54) PRINT SYSTEM, INSPECTION APPARATUS, METHOD OF CONTROLLING INSPECTION APPARATUS, AND STORAGE MEDIUM

(71) Applicant: CANON KABUSHIKI KAISHA, Tokyo (JP)

(72) Inventors: SHINYA SUZUKI, Chiba (JP); YUKI NAKATANI, Chiba (JP)

(21) Appl. No.: 18/596,776

(22) Filed: Mar. 6, 2024

(30) Foreign Application Priority Data
Mar. 16, 2023 (JP) 2023-042319

(51) Int. Cl. G06T 7/00

(52) U.S. Cl. CPC G06T 7/001; G06T 2207/10024; G06T 2207/30144

(57) ABSTRACT

The present invention provides an inspection apparatus and a print system comprising a printing apparatus and the inspection apparatus. The inspection apparatus obtains a read image by reading the printed material, detects an image defect that has occurred in the printed material by comparing the read image and a reference image. The inspection apparatus extracts feature information of the image defect based on difference information between pixel data of the reference image corresponding to a plurality of pixels in a region surrounding the image defect excluding the image defect in the region and pixel data indicating the image defect included in the read image and identifies a cause of the image defect based on the extracted feature information.

### BACKGROUND OF THE INVENTION

### Cross Reference to Priority Application

This application claims the benefit of Japanese Patent Application No. 2023-042319, filed Mar. 16, 2023, which is hereby incorporated by reference herein in its entirety.

### FIELD OF THE INVENTION

The present invention relates to a print system, an inspection apparatus, a method of controlling the inspection apparatus, and a storage medium.

### DESCRIPTION OF THE RELATED ART

There is a technique of inspecting a printed material and detecting an image defect of the printed material. In this technique, an image forming apparatus performs print processing based on an input image, and a printed material outputted by the image forming apparatus is scanned by a reading device to obtain a read image. Then, a print defect is detected from difference information between the read image and the input image (reference image).

In Japanese Patent Laid-Open No. 2007-281959, feature values related to a projected waveform are calculated from information on a difference between input image information serving as a base for an output image and read image information acquired by reading the output image with a reading device, and a set of types defects included in the output image is determined by clustering processing based on the feature values. Then, a test chart corresponding to the set of types of defects is determined from among a plurality of test charts which are to be used to diagnose failures causing image defects. Then, the test chart is printed and read image information is obtained by reading the printed test chart, and the read image information is compared with input image information corresponding to the test chart, and a type of defect occurring in the read image information is determined. A failure of a particular constituent member constituting the image forming apparatus is diagnosed based on the type of the defect determined in this way.

However, as disclosed in Japanese Patent Laid-Open No. 2007-281959, when an image defect feature is extracted from information on the difference between the input image information and the read image information, a deviation may occur between a density signal of the input image information and a density signal of the read image information due to, for example, density unevenness in image portions of the printed test chart. In such a case, a difference may occur between the input image information and the read image information, and a change may occur in a feature such as a shape or a contrast of an image defect in an image portion of the test chart.

In the case when, among members of a printing apparatus, a rotating body such as a photosensitive drum or an intermediate transfer belt is the cause of an image defect, a linear or point-like image defect occurs at periodically in intervals whose distance corresponds to a rotation period in a conveyance direction of a recording material. When identifying such a cause, a period analysis is performed in relation to matching or similar image defect features in order to identify the cause of the image defect. When the feature of an image defect changes as described above, even if the cause of the image defect is the same, the degree of coincidence or the degree of similarity of image defect feature may drop, and identification of the cause of an image defect may become less accurate.

### SUMMARY OF THE INVENTION

Embodiments of the present disclosure eliminate the above-mentioned issues with conventional technology.

A feature of embodiments of the present disclosure is to provide a technique capable of improving accuracy in image defect feature extraction and reliably identifying a cause of an image defect.

According to embodiments of the present disclosure, there is provided a print system comprising a printing apparatus and an inspection apparatus, wherein the printing apparatus that generates a printed material based on print data, and the inspection apparatus, comprising: one or more controllers including one or more processors and one or more memories, the one or more controllers configured to: obtain a read image by reading the printed material; detect an image defect that has occurred in the printed material by comparing the read image and a reference image; extract feature information of the image defect based on difference information between pixel data of the reference image corresponding to a plurality of pixels in a region surrounding the image defect excluding the image defect in the region and pixel data indicating the image defect included in the read image; and identify a cause of the image defect based on the extracted feature information.

According to embodiments of the present disclosure, there is provided an inspection apparatus for receiving and inspecting a printed material that has been printed on a printing apparatus, the inspection apparatus comprising: a reader; and one or more controllers including one or more processors and one or more memories, the one or more controllers configured to: obtain a read image by reading the printed material by using the reader; detect an image defect that has occurred in the printed material by comparing the read image and a reference image; extract feature information of the image defect based on difference information between pixel data of the reference image corresponding to a plurality of pixels in a region surrounding the image defect and excluding the image defect in the region and pixel data indicating the image defect included in the read image; and identify a cause of the image defect based on the extracted feature information.

According to embodiments of the present disclosure, there is provided a method of controlling an inspection apparatus for receiving and inspecting a printed material that has been printed by a printing apparatus, the method comprising: obtaining a read image by reading the printed material; detecting an image defect that has occurred in the printed material by comparing the read image and a reference image; extracting feature information of the image defect based on difference information between pixel data of the reference image corresponding to a plurality of pixels in a region surrounding the image defect excluding the image defect in the region and pixel data indicating the image defect included in the read image; and identifying a cause of the image defect based on the extracted feature information.

Further features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a diagram showing an example of a network configuration including a print system according to a first embodiment of the present invention.

FIG. 2 depicts a schematic cross-sectional view illustrating a hardware configuration example of a print system according to the first embodiment.

FIG. 3 is a block diagram for describing a hardware configuration of a print system, an external controller, and a client PC according to the first embodiment.

FIG. 4 is a flowchart for describing a print operation executed by the external controller and the printing apparatus according to the first embodiment, and a procedure for inspecting printed material executed by the inspection apparatus.

FIG. 5A and FIG. 5B depict views illustrating filters used in the first embodiment.

FIG. 6A and FIG. 6B are flowcharts for describing a procedure of image diagnosis processing performed by the external controller and the print system according to embodiments.

FIG. 7 is a diagram illustrating an example of a test chart according to the first embodiment.

FIG. 8A is a diagram illustrating an example of image defects that have occurred in a test chart.

FIG. 8B depicts a view illustrating an example of an image defect map based on FIG. 8A.

FIG. 9 is a diagram exemplifying image defects A to D which have been cut out from an image of the test chart in which the image defects of FIG. 8A have occurred.

FIG. 10 is a diagram illustrating a reference region when a reference signal is calculated in the first embodiment.

FIG. 11A and FIG. 11B are flowcharts for describing a procedure of image diagnosis processing performed by the external controller and the print system according to a second embodiment.

FIG. 12 is a diagram for describing a reference region when calculating a reference signal for detecting an image defect in the second embodiment.

### DESCRIPTION OF THE EMBODIMENTS

Embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure.

### First Embodiment

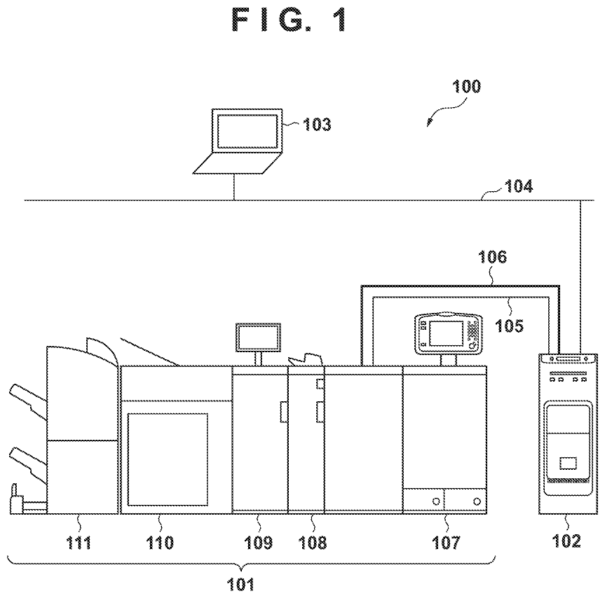

FIG. 1 is a diagram showing an example of a network configuration including a print system 101 according to a first embodiment of the present invention.

The print system 101 is connected to an external controller 102. The print system 101 and the external controller 102 constitute an image processing system. The print system 101 and the external controller 102 are communicatively coupled to each other via an internal LAN 105 and a video cable 106. The external controller 102 is communicatively coupled to a client PC 103 via an external LAN 104.

The client PC 103 can issue a print instruction to the external controller 102 via the external LAN 104. A printer driver is installed in the client PC 103. The printer driver has a function of converting print data into data of a printer description language (Page Description Language (PDL)) that can be processed by the external controller 102. By operating the client PC 103, the user can issue a print instruction to the print system 101 from various applications installed in the PC 103 via the printer driver. The printer driver transmits the print data, that is, PDL data, to the external controller 102 based on a print instruction from the user. Upon receiving PDL data from the client PC 103, the external controller 102 performs analysis and interprets the received PDL data. Then, rasterization processing is performed based on the result of the interpretation, a bitmap image having a resolution matching the print system 101 is generated, and the generated bitmap image is inputted to the print system 101 to thereby give a print instruction. In print systems, the resolution is usually 600 dpi; 1200 dpi in the case of high definition. Hereinafter, the resolution will be described with the example of 600 dpi.

The print system 101 includes a plurality of apparatuses each having a different function, and is configured to be capable of executing various processing such as bookbinding processing. In the first embodiment, the print system 101 includes a printing apparatus 107, an inserter 108, an inspection apparatus 109, a large-volume stacker 110, and a finisher 111. An image is printed on a recording material (sheet) by the printing apparatus 107, and the printed recording material discharged from the printing apparatus 107 is conveyed inside each apparatus in the order of the inserter 108, the inspection apparatus 109, the large-volume stacker 110, and then the finisher 111. In the first embodiment, the print system 101 is an example of an image forming apparatus, but the printing apparatus 107 included in the print system 101 may be referred to as an image forming apparatus.

The printing apparatus 107 uses toner (developer) to form (print) an image on a recording material fed and conveyed from a sheet feeding unit disposed at a lower portion of the printing apparatus 107. The inserter 108 is a device that inserts an insertion sheet into a series of recording material groups conveyed from the printing apparatus 107. The inspection apparatus 109 is an apparatus in which the printed recording material on which an image has been printed by the printing apparatus 107 is conveyed through a conveyance path, and the inspection apparatus 109 inspects the conveyed recording material. More specifically, the inspection apparatus 109 reads an image printed on the conveyed recording material and compares the obtained read image with a reference image registered in advance to inspect the image printed on the recording material (determine whether or not the printed image is normal). The large-volume stacker 110 is a device capable of stacking a large number of recording materials. The finisher 111 is an apparatus capable of executing finishing processing such as stapling processing, punching processing, and saddle stitching processing on the conveyed recording materials. The recording material processed by the finisher 111 is discharged to a predetermined sheet discharge tray.

In the configuration example of FIG. 1, the external controller 102 is connected to the print system 101, but embodiments are also applicable to configurations different from this. For example, it is possible to use a configuration in which the print system 101 is connected to the external LAN 104 and print data is transmitted from the client PC 103 to the print system 101 without going through the external controller 102. In this case, data analysis and rasterization of the print data are executed by the print system 101.

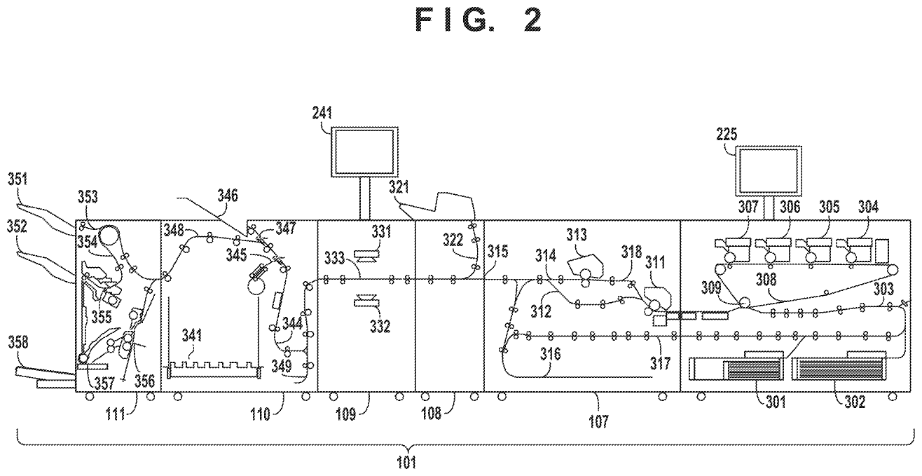

FIG. 2 depicts a schematic cross-sectional view illustrating a hardware configuration example of the print system 101 according to the first embodiment. Hereinafter, a specific operation example of the print system 101 will be described with reference to FIG. 2.

In the printing apparatus 107, various recording materials are stored in paper feed decks 301 and 302. Among the recording materials stored in the respective printing decks, one by one the recording material positioned uppermost is separated and fed to a conveyance path 303. Image forming stations 304 to 307 each include a photosensitive drum (photosensitive member), and form a toner image on the photosensitive drum using toner of respectively different colors. Specifically, the image forming stations 304 to 307 form toner images using yellow (Y), magenta (M), cyan (C), and black (K) toners, respectively.

The toner images of the respective colors formed in the image forming stations 304 to 307 are sequentially transferred onto an intermediate transfer belt 308 in a superimposed manner (primary transfer). The toner image transferred to the intermediate transfer belt 308 in this manner is conveyed to a secondary transfer position 309 in accordance with the rotation of the intermediate transfer belt 308. At the secondary transfer position 309, the toner image is transferred from the intermediate transfer belt 308 to the recording material conveyed through the conveyance path 303 (secondary transfer). The recording material after the secondary transfer is conveyed to a fixing unit 311. The fixing unit 311 includes a pressure roller and a heating roller. When heat and pressure are applied to the recording material while the recording material passes between the rollers, fixing processing for fixing the toner image onto the recording material is performed. The recording material, after passing through the fixing unit 311, passes through a conveyance path 312 and is conveyed to a connection point 315 between the printing apparatus 107 and the inserter 108. In this way, a color image is formed (printed) on the recording material.

When further fixing processing is required in accordance with the type of the recording material, the recording material, after having passed through the fixing unit 311, is guided to a conveyance path 314 on which a fixing unit 313 is provided. The fixing unit 313 performs further fixing processing on the recording material conveyed through the conveyance path 314. The recording material, after having passed through the fixing unit 313, is conveyed to the connection point 315. When an operation mode for performing double-sided printing is set, an image is printed on the first surface, and the recording material conveyed on the conveyance path 312 or the conveyance path 314 is guided to a reversing path 316. The recording material reversed by the reversing path 316 is guided to a double-sided conveyance path 317 and conveyed to the secondary transfer position 309. As a result, the toner image is transferred to the second surface of the recording material opposite to the first surface at the secondary transfer position 309. Thereafter, the recording material passes through the fixing unit 311 (and the fixing unit 313), and thus the formation of a color image on the second surface of the recording material is completed.

Formation (printing) of an image in the printing apparatus 107 is completed, and the recording material conveyed to the connection point 315 is conveyed into the inserter 108. The inserter 108 includes an inserter tray 321 in which recording materials to be inserted are set. The inserter 108 performs processing for inserting a recording material (insertion sheet) fed via a conveyance path 322 from the inserter tray 321 into an arbitrary insertion position in a series of recording material groups conveyed from the printing apparatus 107 and conveying the recording materials to a subsequent apparatus (the inspection apparatus 109). Recording materials, after passing through the inserter 108, are conveyed in order to the inspection apparatus 109.

The inspection apparatus 109 includes Contact Image Sensors (CISs) 331 and 332, which are image readers, on a conveyance path 333, on which recording materials from the inserter 108 are conveyed. The CISs 331 and 332 are disposed at positions opposite to each other across the conveyance path 333. The CISs 331 and 332 are configured to read an upper surface (first surface) and a lower surface (second surface) of the recording material, respectively. Note that the image reader may be constituted by, for example, a CCD or a line-scan camera in place of a CIS.

The inspection apparatus 109 performs inspection processing for inspecting an image printed on a recording material conveyed through the conveyance path 333. Specifically, the inspection apparatus 109 performs reading processing for reading an image of the recording material using the image readers (331, 332) when the recording material being conveyed reaches a predetermined position. Further, the inspection apparatus 109 inspects the image printed on the recording material based on the image obtained by the reading processing. The recording material, after having passed through the inspection apparatus 109, is sequentially conveyed to the large-volume stacker 110.

In the first embodiment, the inspection apparatus 109 performs inspection processing by comparing a read image obtained by reading the image printed on the recording material with a reference image registered in advance. As a method of comparing images in the inspection processing, for example, a method of comparing pixel values (pixel data) for each pixel, a method of comparing positions of objects obtained by edge detection, and a method of extracting character data by Optical Character Recognition (OCR) may be used. In addition, the inspection apparatus 109 performs processing for inspecting an image defect with respect to an inspection item set in advance. Examples of inspection items may include misalignment of a printing position of an image, color tone of an image and density of an image, and streaks or fading occurring in an image, print dropout, and the like.

The large-volume stacker 110 includes a stack tray 341, which is a tray on which the recording materials conveyed from an apparatus (the inspection apparatus 109) on the upstream side in the conveyance direction of the recording material are stacked. The recording material, after having passed through the inspection apparatus 109, is conveyed to a conveyance path 344 in the large-volume stacker 110. When the recording material, after being conveyed through the conveyance path 344, is guided to a conveyance path 345, the recording material is stacked on the stack tray 341.

The large-volume stacker 110 further includes an escape tray 346 as a discharge tray. In the first embodiment, the escape tray 346 is used to discharge a recording material determined to have an image defect in a printed image as a result of inspection by the inspection apparatus 109. When the recording material, after being conveyed through the conveyance path 344, is guided to a conveyance path 347, the recording material is conveyed to the escape tray 346. The recording material, after having been conveyed without being stacked or discharged in the large-volume stacker 110, is conveyed to the subsequent finisher 111, through a conveyance path 348.

The large-volume stacker 110 further includes a reversing unit 349 for reversing the direction of the conveyed recording material. The reversing unit 349 is used, for example, to make the orientation of the recording material inputted into the large-volume stacker 110 the same as the orientation of the recording material when stacked on the stack tray 341 and outputted from the large-volume stacker 110. Note that the reversing operation by the reversing unit 349 is not performed on a recording material that is to be conveyed to the finisher 111 without being stacked in the large-volume stacker 110.

The finisher 111 executes a finishing function designated by the user on recording materials conveyed from the apparatus (the inspection apparatus 109) on the upstream side in the conveyance direction of the recording materials. In the first embodiment, the finisher 111 has, for example, a finishing function such as a stapling function (one or two binding positions), a punching function (two holes or three holes), and a saddle stitching function. The finisher 111 includes two discharge trays 351 and 352. In a case where the finishing processing by the finisher 111 is not performed, the recording material conveyed to the finisher 111 is discharged to the discharge tray 351 through a conveyance path 353. In a case where finishing processing such as stapling processing is performed by the finisher 111, the recording materials conveyed to the finisher 111 are guided to a conveyance path 354. The finisher 111 executes finishing processing specified by the user on the recording materials conveyed on the conveyance path 354 by using a processing unit 355, and discharges the recording materials to the sheet discharge tray 352. When saddle stitch binding is designated, a saddle stitching processing unit 356 performs stapling processing on the center of the recording materials, folds the recording materials into two, and outputs the folded recording materials to a saddle stitch binding tray 358 via a sheet conveyance path 357. The saddle stitch binding tray 358 is configured to have a conveyor belt configuration, and the saddle stitch binding bundle stacked on the saddle stitch binding tray 358 is conveyed to the left.

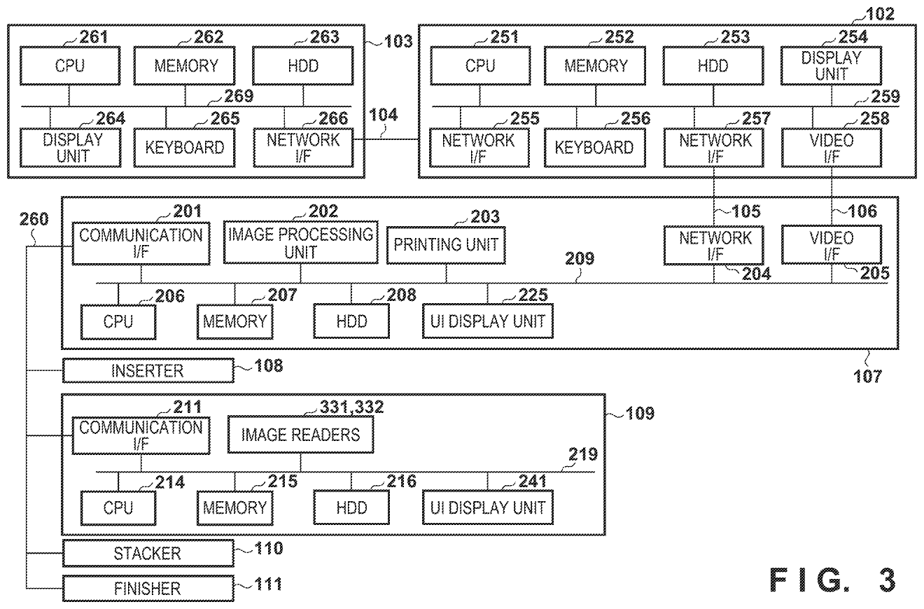

FIG. 3 is a block diagram for describing a hardware configuration of the print system 101, the external controller 102, and the client PC 103 according to the first embodiment. First, the configuration of the printing apparatus 107 will be described.

The printing apparatus 107 of the print system 101 includes a communication interface (I/F) 201, a network I/F 204, a video I/F 205, a CPU 206, a memory 207, and a hard disk drive (HDD) 208, and a user interface (UI) display unit 225. The printing apparatus 107 further includes an image processing unit 202 and a printing unit 203. These are connected to each other via a system bus 209.

The communication I/F 201 is connected to the inserter 108, the inspection apparatus 109, he large-volume stacker 110, and the finisher 111 via a communication cable 260. The CPU 206 performs communication to control each device via a communication I/F 201. The network I/F 204 is connected to the external controller 102 via the internal LAN 105 and is used for communication of control data and the like. The video I/F 205 is connected to the external controller 102 via the video cable 106 and is used for communication of image data and the like. Note that the printing apparatus 107 (the print system 101) and the external controller 102 may be connected only by the video cable 106 as long as the operation of the print system 101 can be controlled by the external controller 102.

Various programs and data are stored in the HDD 208. The CPU 206 controls the operation of the printing apparatus 107 as a whole by deploying a program stored in the HDD 208 in the memory 207 and executing the program. The memory 207 stores programs and data that are required when the CPU 206 performs various processes. The memory 207 operates as a work area for the CPU 206. The UI display unit 225 receives instructions for inputting and operating various settings from a user, and is used to display various types of information such as setting information and a processing status of a print job.

The inserter 108 controls feeding of the inserted recording material from the sheet feeding unit and conveyance of the recording material conveyed from the printing apparatus 107.

Next, the configuration of the inspection apparatus 109 will be described.

The inspection apparatus 109 includes a communication I/F 211, a CPU 214, a memory 215, an HDD 216, the image readers 331 and 332, and a UI display unit 241. These devices are connected to each other via a system bus 219. The communication I/F 211 is connected to the printing apparatus 107 via the communication cable 260. The CPU 214 performs communication necessary to control the inspection apparatus 109 via the communication I/F 211. The CPU 214 controls operation of the inspection apparatus 109 by executing a control program stored in the memory 215. The memory 215 stores a control program for the inspection apparatus 109.

The image readers 331 and 332 read the conveyed recording material in accordance with an instruction from the CPU 214. The CPU 214 performs processing for storing the read images obtained by the image readers 331 and 332 reading the recording material into the HDD 216 as reference images for inspection. The CPU 214 further compares inspection target images (read images) read by the image readers 331 and 332 with reference images for inspection stored in the HDD 216, and performs inspection processing for inspecting the target images printed on the recording material based on the comparison result. The reference images for inspection are images read by the image readers 331 and 332, but the inspection processing can also be performed using a bitmap image obtained by rasterizing PDL data as a defect inspection reference image.

The UI display unit 241 is used to display an inspection result, a setting screen, and the like. An operation unit of the inspection apparatus 109 is also used as the UI display unit 241, and is operated by a user to receive various instructions (for example, a change to settings of the inspection apparatus 109, an inspection reference image registration instruction, an instruction to execute an image diagnosis, and the like) from the user. The HDD 216 stores various setting information and image data required for inspection of image defects. The various setting information and image data stored in the HDD 216 can be reused as well.

The large-volume stacker 110 performs control to discharge the recording material conveyed on the conveyance path to the stack tray, discharge the recording material to the escape tray 346, or convey the recording material to the finisher 111 connected to the downstream side in the conveyance direction.

The finisher 111 controls conveyance and discharge of recording materials, and performs finishing processing such as stapling, punching, or saddle stitching.

Next, the configuration of the external controller 102 will be described.

The external controller 102 include a CPU 251, memory 252, an HDD 253, a keyboard 256, a display unit 254, network I/Fs 255 and 257, and a video I/F 258. These devices are connected to each other via a system bus 259. The CPU 251 deploys a program stored in the HDD 253 into the memory 252 and executes the program, thereby controlling operations of the external controller 102 as a whole (for example, reception of print data from the client PC 103, RIP processing, and transmission of print data to the print system 101). The memory 252 stores programs and data that are required when the CPU 251 performs various processes. The memory 252 operates as a work area for the CPU 251.

Various programs and data are stored in the HDD 253. The keyboard 256 is used to input an operation instruction of the external controller 102 from the user. The display unit 254 is used, for example, to display information of an application being executed in the external controller 102 and an operation screen. The network I/F 255 is connected to the client PC 103 via the external LAN 104 and is used for communication of data such as a print instruction or the like. The network I/F 257 is connected to the print system 101 via the internal LAN 105 and is used for communication of data such as a print instruction or the like. The external controller 102 is configured to be able to communicate with the printing apparatus 107, the inserter 108, the inspection apparatus 109, the large-volume stacker 110, and the finisher 111 via the internal LAN 105 and the communication cable 260. The video I/F 258 is connected to the print system 101 via the video cable 106 and is used for communication of data such as image data (the print data) and the like.

Next, the configuration of the client PC 103 will be described.

The client PC 103 includes a CPU 261, a memory 262, an HDD 263, a keyboard 265, a display unit 264, and a network I/F 266. These devices are connected to each other via a system bus 269. The CPU 261, via the system bus 269, controls the operation of each device by deploying a program stored in the HDD 263 in the memory 252 and executing the program. As a result, various processes by the client PC 103 are realized. For example, the CPU 261 deploys and executes a document processing program stored in the HDD 263 in the memory 252 to generate print data and give a print instruction. The memory 262 stores programs and data that are required when the CPU 261 performs various processes. The memory 262 operates as a work area for the CPU 261.

The HDD 263 stores programs such as various applications (e.g., document processing programs) and printer drivers, and various types of data. The keyboard 265 is used to input an operation instruction of the client PC 103 from the user. The display unit 264 is used, for example, to display information of an application being executed in the client PC 103 and an operation screen. The network I/F 266 is connected to the external controller 102 via the external LAN 104 so as to be able to communicate therewith. The CPU 261 communicates with the external controller 102 via the network I/F 266.

In the configuration example of FIG. 1, the external controller 102 is connected to the print system 101, but embodiments are also applicable to configurations different from this. For example, it is possible to use a configuration in which the print system 101 is connected to the external LAN 104 and print data is transmitted from the client PC 103 to the print system 101 without going through the external controller 102. In this case, data analysis, interpretation, and rasterization for the print data are executed by the print system 101.

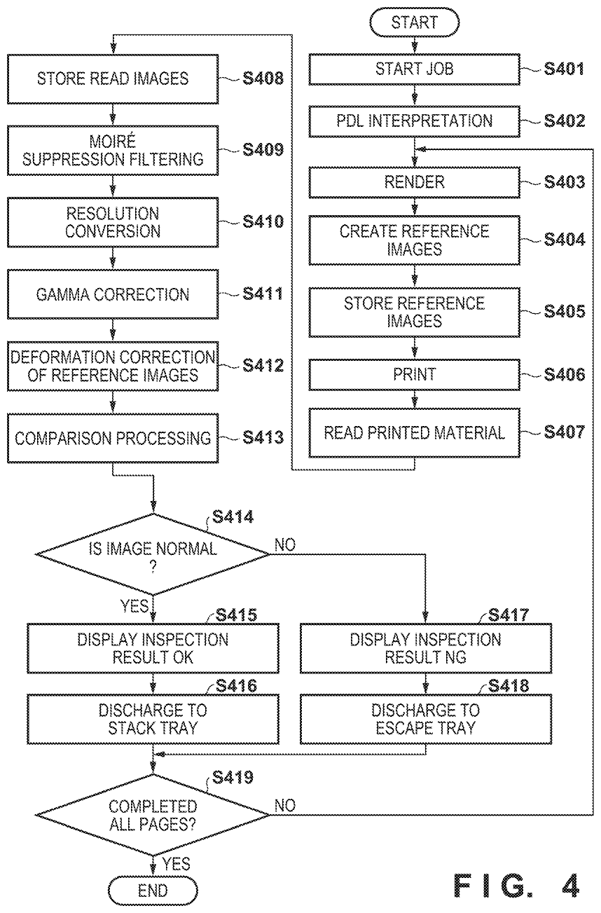

FIG. 4 is a flowchart for describing a print operation executed by the external controller 102 and the printing apparatus 107 according to the first embodiment, and an inspection processing procedure for inspecting whether or not there is an image defect in a printed material, which is executed by the inspection apparatus 109. The processing of the steps in FIG. 4 is executed by the CPU 251 of the external controller 102, the CPU 206 of the printing apparatus 107, and the CPU 214 of the inspection apparatus 109. In the present example, as a print setting, a setting in which the large-volume stacker 110 is the discharge destination of the printed material (that is, a setting in which the stack tray 341 of the large-volume stacker 110 is the discharge destination) is performed in advance.

First, in step S401, execution of a print job is started in response to a print instruction from the client PC 103 or the external controller 102. In the first embodiment, for the sake of simplicity, the following description will treat PDL data as a Portable Document Format (PDF) including character images, and an example will be given in which an instruction to directly print the PDF is given to the external controller 102. The processing next proceeds to step S402, and the CPU 251 of the external controller 102 interprets PDL data from the description in PDF print job file, and obtains the font type, the size, the designated position in the sheet, and the like of the character to be printed. Next, the processing proceeds to step S403, and the CPU 251 rasterizes bitmaps according to the resolution setting as interpreted by PDL interpreter. Next, the processing proceeds to step S404, and the CPU 251 creates reference images based on the rasterized bitmaps and, in step S405, temporarily stores the reference images in the HDD 253 of the external controller 102. The reference images are then sent to the inspection apparatus 109 and stored in the HDD 216 of the inspection apparatus 109. The resolution of the reference images is 600 dpi.

Next, the processing proceeds to step S406, and the CPU 251 transmits the rasterized bitmap data from the video I/F 258 through the video cable 106 to the video I/F 205 of the printing apparatus 107. The CPU 206 of the printing apparatus 107, after having received the bitmap data in this way, prints the image data by using the printing unit 203. Then, the printed material is discharged and conveyed to the inspection apparatus 109.

Then, the processing proceeds to step S407, and the CPU 214 of the inspection apparatus 109 reads the conveyed the printed material by the image readers 331 and 332. Next, the processing proceeds to step S408, and the CPU 214 stores the read images as inspection target images in the HDD 216 of the inspection apparatus 109. The resolution at the time of reading the printed material by the image readers 331 and 332 will be described hereinafter as 600 dpi in the embodiment.

Next, the processing proceeds to step S409, and the CPU 214 performs moiré suppression filter processing on the read images of the printed material obtained by the image readers 331 and 332. This is performed in order to suppress a high-frequency pattern, leave a low-frequency component, and prevent interference fringes (moiré) from occurring when resolution conversion is performed. Next, the processing proceeds to step S410, and the CPU 214 converts the resolution of the read images into 300 dpi. This is to shorten the computation time of deformation correction (alignment) of the reference images of step S412 to be performed later and processing for comparing the reference images and the read images. In the first embodiment, the resolution is converted into 300 dpi based on the size of the image defect to be detected. Next, the processing proceeds to step S411, and the CPU 214 performs a gamma correction of the read images by using a look-up table stored in the memory 215 of the inspection apparatus 109 so as to match the gradation of the reference images with the gradation of the read images. Next, the processing proceeds to step S412, and the CPU 214 performs a deformation correction of the reference images and performs the alignment between the read images and the reference images subjected to the deformation correction in step S412. Then the processing proceeds to step S413, and the CPU 214 compares the read images read and converted in step S407 with the reference images resulting from the deformation correction in step S412. When the image comparison processing is completed, the processing proceeds to step S414, and the CPU 214 determines whether or not the printed images are normal as a result of the comparison with the reference images in the comparison processing.

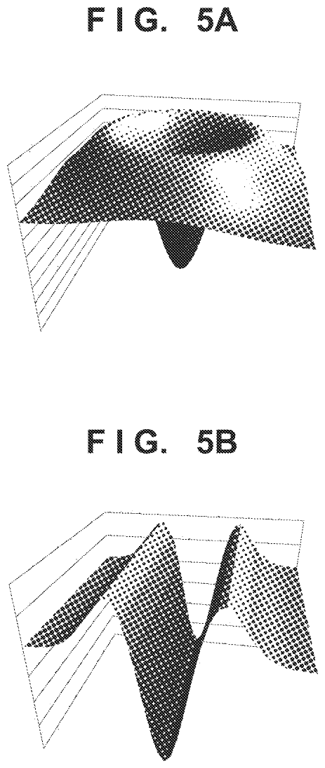

This determination is performed as follows. First, filter processing for emphasizing a specific shape is performed on a difference image based upon differences between a reference image and a read image. As an example, FIG. 5A illustrates a filter for highlighting point-like defects, and FIG. 5B illustrates a filter for highlighting linear defects. Binarization processing is performed on the difference image after emphasis processing so that the value is “1” if the difference value is equal to or larger than the threshold value, and the value is “0” if the difference value is less than the threshold value. It is determined whether or not there is a pixel in the image resulting from the binarization processing being performed in this way that is “1” where the threshold value is exceeded; if no such pixel present, it is determined that the read image is normal, but if such a pixel is present, it is determined that the read image is not normal, that is, there is an image defect. In embodiments, threshold values are set such that a point-like defect having a diameter of 400 μm or more is detected as a defect and a linear defect having a width of 500 μm or more is detected as an image defect. Further, by changing an inspection level, it is possible to change the size of the image defect to be detected. However, the inspection processing is not limited to the above-described method, and the type of the inspection processing is not limited as long as the inspection processing can detect an image defect as desired by the user.

In step S414, when it is determined that the read images are normal, that is, there is no image defect in the read image, the processing advances to step S415 and the CPU 214 displays an inspection result indicating that the printed images are normal on the UI display unit 241 of the inspection apparatus 109. Next, the processing proceeds to step S416, and the CPU 214 instructs the printing apparatus 107 to discharge the printed material to the stack tray 341 of the large-volume stacker 110. Accordingly, the printing apparatus 107 instructs the large-volume stacker 110 to discharge the conveyed printed material to the stack tray 341 based on an instruction from the inspection apparatus 109. In this way, printed materials having no image defect are conveyed to the stack tray 341 of the large-volume stacker 110 and accumulated.

Meanwhile, in step S414, when it is determined that any one of the read images is not normal (there is an image defect), the processing advances to step S417 and the CPU 214 displays an inspection result indicating that the printed image is not normal on the display unit 241 of the inspection apparatus 109. Next, the processing proceeds to step S418, and the CPU 214 instructs the printing apparatus 107 to discharge the printed material to the escape tray 346 of the large-volume stacker 110. Accordingly, the printing apparatus 107 instructs the large-volume stacker 110 to discharge the conveyed printed material to the escape tray 346 based on an instruction from the inspection apparatus 109. In this way, the printed material having an image defect is conveyed to the escape tray 346 of the large-volume stacker 110 and accumulated. When step S416 or step S418 is executed in this way, the processing proceeds to step S419, and the CPU 214 determines whether or not the print and inspection processing has been completed for all the pages, and when it is determined that the print and inspection processing has been completed for all the pages, the processing ends. Meanwhile, if it is determined that the processing has not ended, the processing proceeds to step S403, and the CPU 251 of the external controller 102, the CPU 206 of the printing apparatus 107, and the CPU 214 of the inspection apparatus 109 continue the processing of step S403 to step S418 described above.

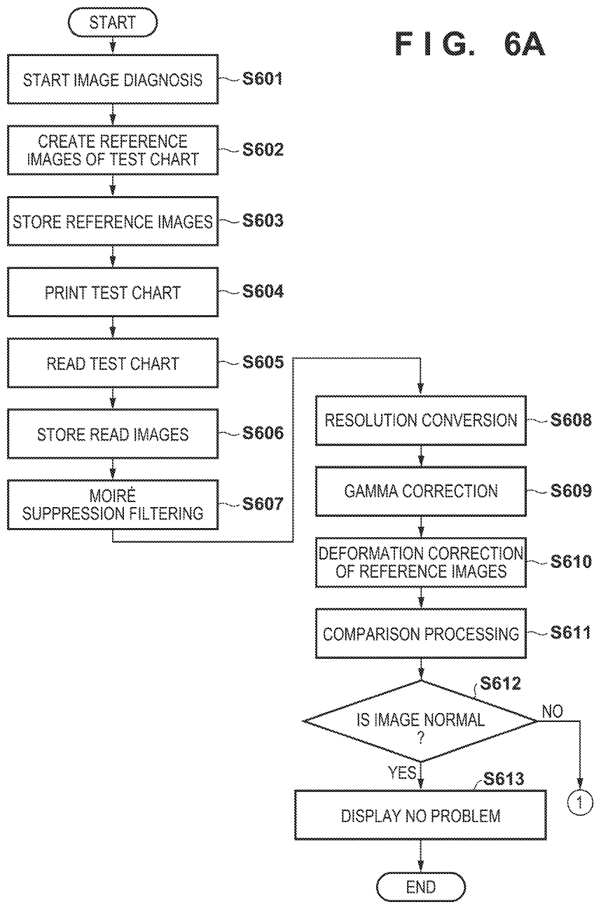

Next, image diagnosis processing according to the first embodiment will be described with reference to FIG. 6A to FIG. 10.

FIGS. 6A and 6B are flowcharts for describing a procedure of image diagnosis processing performed by the external controller 102 and the print system 101 according to embodiments.

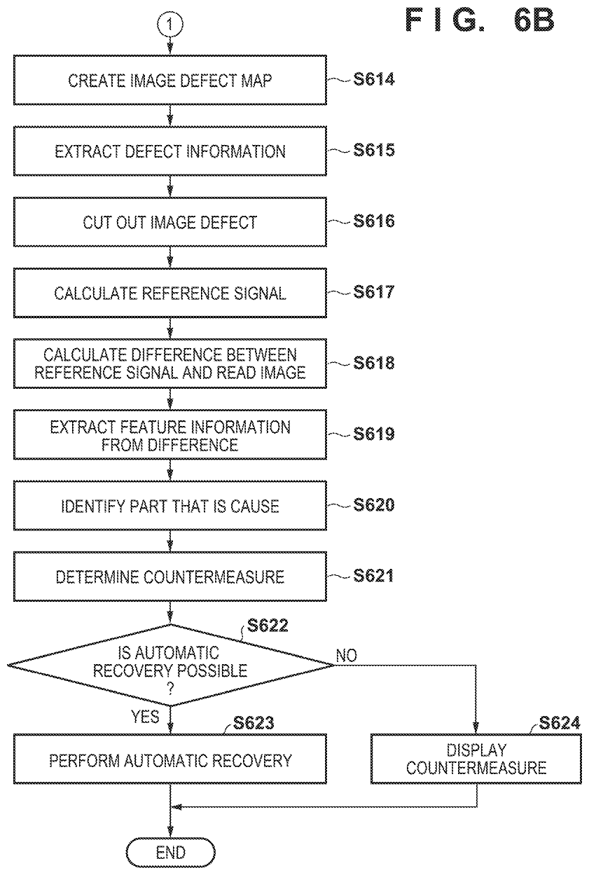

First, in step S601, image diagnosis processing is started when an instruction for image diagnosis is given by a user or a serviceman from the UI display unit 241 that also serves as an operating unit of the inspection apparatus 109. Next, the processing proceeds to step S602, and an instruction for image diagnosis is sent to the external controller 102 via the printing apparatus 107, so that the CPU 251 of the external controller 102 creates rasterized bitmap image data of a test chart 700 as shown in FIG. 7, for example, as a reference image. Then, the CPU 251 of the external controller 102 proceeds to step S603 and temporarily stores the reference image of the test chart in the HDD 253 of the external controller 102. Thereafter, the CPU 251 sends the reference image to the inspection apparatus 109, and thereby causes the reference image to be stored in the HDD 216 of the inspection apparatus 109. The resolution of the reference image will be described hereinafter as 600 dpi.

Next, the processing proceeds to step S604, and the CPU 251 of the external controller 102 transmits rasterized bitmap image data from the video I/F 258 through the video cable 106 to the video I/F 205 of the printing apparatus 107. The CPU 206 of the printing apparatus 107, after having received the bitmap image data in this way, prints the test chart by using the printing unit 203.

FIG. 7 is a diagram illustrating an example of a test chart according to the first embodiment.

As illustrated in FIG. 7, the test chart 700 includes a non-image area 701 disposed at the leading-edge side of the chart, and an intermediate tone image area 702 that occupies almost the entirety of the test chart. An image of the intermediate tone image area 702 of such a chart is formed with yellow (Y), magenta (M), cyan (C), and black (K) toners, and the result is used as a test chart. In the first embodiment, the test chart 700 is printed on double sides of a recording medium with a double-sided printing by the printing apparatus 107 and the test chart 700 are respectively read by the image readers 331 and 332 will be described. If any of the image readers 331 and 332 is used to read the test chart 700, the test chart 700 may be printed on a single side of a recording medium. The rasterized bitmap image data of the test chart 700 is stored in the HDD 216 as the reference image.

Then, the processing proceeds to step S605, and the CPU 214 of the inspection apparatus 109 reads the printed test chart by using the image readers 331 and 332. Next, in step S606, the CPU 214 stores the read images as inspection target images in the HDD 216 of the inspection apparatus 109. The resolution at the time of reading the printed test chart by the image readers 331 and 332 will be described hereinafter as 600 dpi in the embodiment.

Next, the processing proceeds to step S607, and the CPU 214 performs moiré suppression filter processing on the read images of the printed material obtained by the image readers 331 and 332. Next, the processing proceeds to step S608, and the CPU 214 converts the resolution of the read images into 300 dpi. Next, the processing proceeds to step S609, the CPU 214 performs a gamma correction of the read images by using a look-up table stored in the memory 215 of the inspection apparatus 109 so as to match the gradation of the reference images with the gradation of the read images. Next, the processing proceeds to step S610, and the CPU 214 performs a deformation correction of the reference image and performs the alignment between the read images and the reference image subjected to the deformation correction in step S610. Then, the processing proceeds to step S611, and the CPU 214 performs processing for comparing the test chart reference image resulting from the resolution condition adjustment and the like with the read images. When the image comparison processing is completed, the processing proceeds to step S612, and the CPU 214 executes inspection processing for inspecting whether or not the printed test chart is normal as a result of the comparison of the reference image and the read images in the comparison processing, and thereby determines whether or not there is an image defect in the read images. In embodiments, the inspection processing is similar to the inspection processing described in FIG. 4, and threshold values are set such that point defects having a diameter of 400 μm or more and linear defects having a width of 500 μm or more are detected as image defects.

In step S612, if it is determined that the printed test chart image is normal, the processing proceeds to step S613, and the CPU 214 displays an image diagnosis result indicating that there is no problem on the UI display unit 241 of the inspection apparatus 109, and ends the processing. Meanwhile, in step S612, in a case where it determines that the printed test chart is not normal (there is an image defect in any one of the read images), the processing advances to step S614. In step S614, the CPU 214 creates an image defect map.

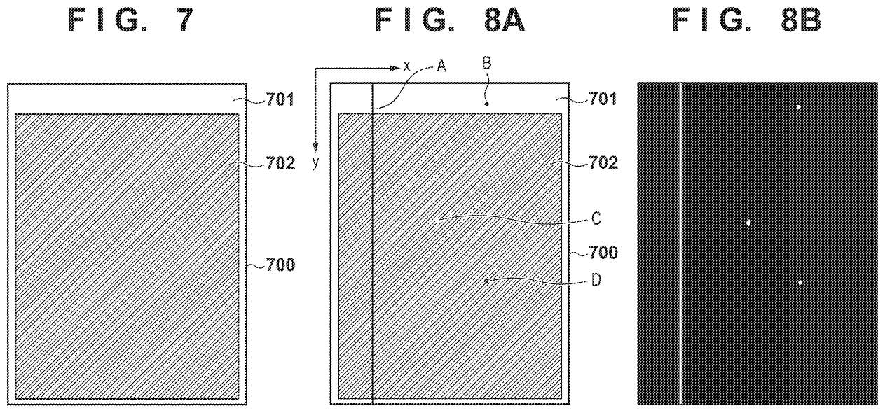

FIG. 8A is a diagram illustrating an example of image defects that have occurred in a read image of the test chart, and FIG. 8B is a diagram illustrating an example of an image defect map based on FIG. 8A.

The read image of the test chart in FIG. 8A includes a vertical streak defect A extending from the leading edge to the trailing edge of the test chart 700, a black point-like defect B occurring in the non-image area 701, a white point-like defect C occurring in the intermediate tone image area 702, and a black point-like defect D occurring in the intermediate tone image area 702. In a case where such a test chart is printed, an image defect map as shown in FIG. 8B is obtained by binarizing a difference image where image defect portions remain as the difference image as the result of comparing the reference image of the test chart with the read image in step S611.

Next, the processing proceeds to step S615, and the CPU 214 extracts defect information from image defect maps. Here, the defect information includes, for the image defects A to D, the types of defects, their positions where the upper left corner of the test chart is a reference point, and their sizes. The positions are represented by a position of the image defect in the x direction which is perpendicular to the conveyance direction of the test chart, and a position of the image defect in the y direction which is parallel to the conveyance direction of the test chart. The sizes are a size of the image defect in the x direction and a size of the image defect in the y direction. Further, the image defects are classified into types such as, for example, vertical streak defect, horizontal streak defect, and point-like defect.

Next, the processing proceeds to step S616, and the CPU 214 cuts out image defects from the read image based on the defect information extracted in step S615.

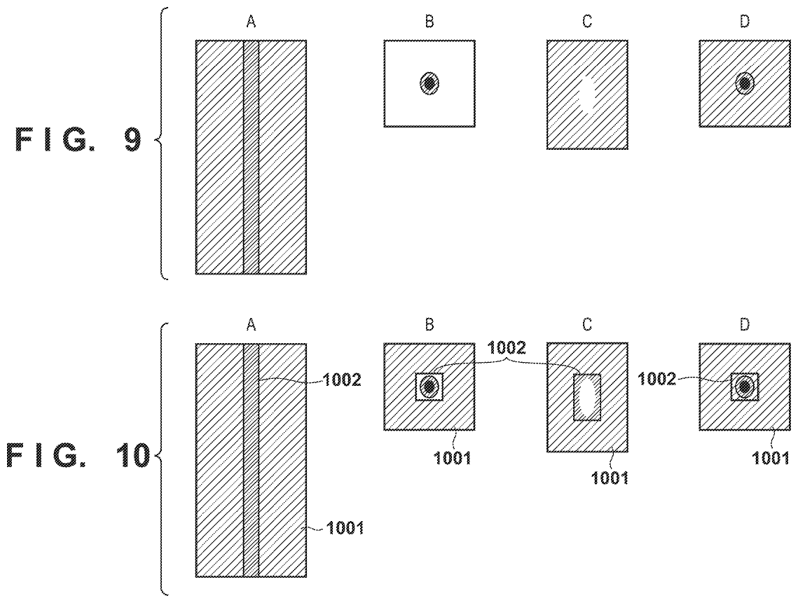

FIG. 9 is a diagram exemplifying image defects A to D which have been cut out from an image of the test chart in which the image defects of FIG. 8 have occurred.

In the first embodiment, for the point-shaped image defects B to D, a rectangle surrounding the image defect with the image defect at its center and having 2 mm lengths from the defect edge portions in the x direction and the y direction of the image defect respectively is cut out. The x direction is perpendicular to the conveyance direction of the test chart and the y direction is parallel to the conveyance direction of the test chart. As described above, each rectangle has a side that is a predetermined length away from the upper, lower, left, and right edge portions of the point-like image defect. This is because, when, in a later step S617, a reference signal is calculated from the cut-out defect image, if the area of the cut-out defect image is too small, there will be variation in the reference signal due to an uneven texture of the recording material on which the test chart is printed. In a case where the area of the cut-out defect image is too large, if density unevenness is present in the intermediate tone image area 702 of the printed test chart, a difference will occur between the reference signal and the density signal of the halftone image in the vicinity of the image defect. Therefore, the size of rectangles in which image defects are to be cut out was set as described above. Further, when feature information of an image defect such as contrast, shape, or the like can be accurately extracted in later step S619, similar image defects can be reliably detected from a plurality of image defects that occur in the read image of the test chart. As a result, it is possible to reliably identify the cause of an image defect periodically occurring in the y direction from the distance in the y direction to a similar image defect.

In addition, the length of a longitudinal streak-like defect A in the y direction was 420 mm from the leading edge to the trailing edge of the test chart. Centered upon the vertical streak-shaped defect A, a rectangle whose widths to each of the right and left of the edge portions of the streak-shaped defect in the x direction is 2 mm, and whose length in the y direction is 10 mm was cut out. Since the vertical streak-like defect A is not a periodically occurring image defect, and it is not necessary to perform a similarity determination, variation in the reference signal has little influence on the identification of the cause of the image defect.

Next, the processing proceeds to step S617, and the CPU 214 calculates reference signals for extracting feature information of an image defect.

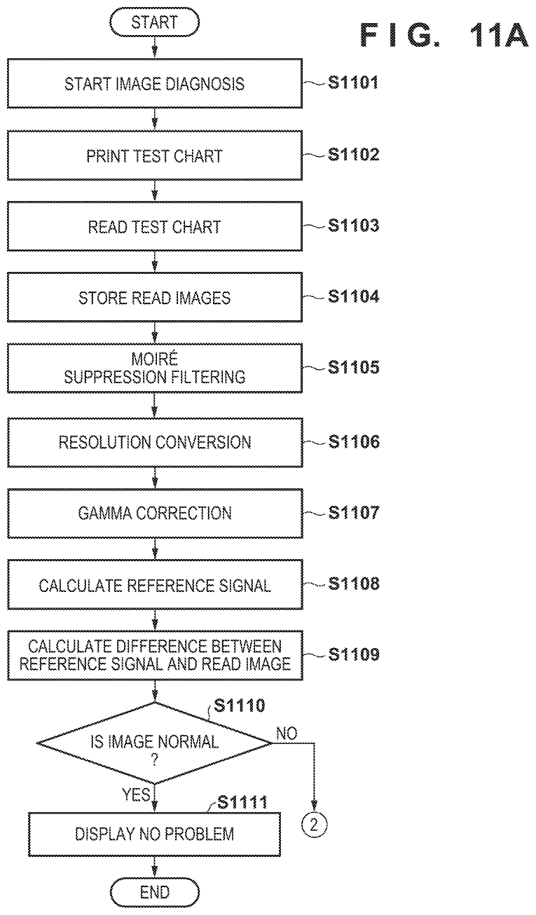

FIG. 10 is a diagram for describing a reference region for calculating a reference signal for extraction of the feature information in the first embodiment.

In FIG. 10, the reference signal is calculated from RGB signal values of pixels in the read image of the hatched area 1001 of each of the cut-out image defects A to D. As illustrated in FIG. 10, the hatched area 1001 is a region in the vicinity of the image defect and excluding the image defect. For image defect A, a rectangle 1002 with the x direction size of the image defect obtained in step S615 and a y direction size of 10 mm is arranged to be in the center of the cut-out rectangular image (FIG. 9) of the image defect A; the hatched area 1001 corresponds to the pixels of the rectangular image excluding pixels inside the rectangle 1002 from the cut-out rectangular image. For image defects B through D, a rectangle 1002 with the x direction size and y direction size of the image defect obtained in step S615 is arranged to be in the center of the respective cut-out rectangular image; the hatched area 1001 corresponds to the pixels of the rectangular image excluding pixels inside the rectangle 1002 from the respective cut-out rectangular image. The average value of RGB signal values of the pixels of the hatched area 1001 corresponding to each of the image defects A to D is calculated, and the average values are set as the reference signal (first reference image data) of the image defects A to D respectively.

Next, the processing proceeds to step S618, and the CPU 214 performs difference calculation processing on the reference signals calculated in step S617 and RGB signal values of the pixels of the defect image cut out in step S616 to obtain difference data. Next, the processing proceeds to step S619, and the CPU 214 extracts feature information in relation to the image defects represented by the difference data obtained in step S618. The feature information of the image defect includes color information such as whether it is single color—yellow, magenta, cyan, or black—or a multi-order color occurring in a plurality of colors; contrast information indicating the density of the image defect; and shape information such as a size or a vertical length, or the like. Further, coordinate information may be a position in the x direction perpendicular to the conveyance direction of the test chart in the printing apparatus 107; periodicity information as to when image defects having similar features in the y direction which is parallel to the conveyance direction of the test chart in the printing apparatus 107 periodically occur; and the like.

Next, the processing proceeds to step S620, and the CPU 214 identifies the cause of the image defect in the printing apparatus 107 and the inspection apparatus 109 based on the feature information of the image defect. Next, the processing proceeds to step S621, and the CPU 214 determines a countermeasure for the image defect based on the cause of the image defect. Types of countermeasures include a countermeasure that can be dealt with by a user such as cleaning to remove dirt on the reading surface of the image readers 331 and/or 332 of the inspection apparatus 109, adjustment of the recording material, or the like. In addition, there are countermeasures that a serviceman performs, such as part replacement. In addition, the printing apparatus 107 can automatically handle and recover from a defect by cleaning a wire or grid of a corona charger, which is a charging unit of a photosensitive drum provided in image forming stations 304 to 307 of the printing apparatus 107, or the like. In addition, there is no need for a countermeasure when the cause of the defect is fibers or foreign matter that got into the recording material prior to image formation being performed.

Next, the processing proceeds to step S622, and the CPU 214 determines whether automatic recovery is possible by the countermeasure determined in step S621. The processing proceeds to step S623 when the automatic recovery is possible by the determined countermeasure, the CPU 214 performs automatic recovery control corresponding to the cause of the image defect, and ends the processing. Meanwhile, if automatic recovery is not possible by the countermeasure determined in step S621, the processing proceeds to step S624, and the CPU 214 displays the image diagnosis result and the countermeasure therefor on the UI display unit 241 of the inspection apparatus 109, and ends the image diagnosis processing.

As described above, according to the first embodiment, when a feature of the image defect is extracted, a reference signal is obtained from a rectangular region in the vicinity of the image defect and excluding the image defect, and feature information of the image defect is extracted from the difference between the reference signal and pixels of the image defect included in a read image. Then, image diagnosis processing for identifying a cause of an image defect from the feature information of the image defect can be executed when the image defect is detected in the inspection processing and when an increase in the frequency thereof is observed.

As a result, it is possible to resolve and recover from the cause of the image defect at an early stage by reliably identifying the cause of the image defect and executing processing for countering the cause. Further, by executing such diagnostic processing before the user starts printing, it is possible to reliably discover an image defect and to guarantee that there is no problem in the printing apparatus. In addition, it is possible to prevent the generation of a printed material that includes an image defect.

In the first embodiment, the image diagnosis processing is performed using a test chart, but image diagnosis processing as described above may be performed by reading a printed material of arbitrary image by using an image reader.

In addition, in the first embodiment, the image defect is cut out in a rectangular shape having sides 2 mm away from the defect edge portions in the x direction and the y direction of the image defect respectively, but the present invention is not limited thereto. For example, the image defect may be cut out as a rectangle having a size several times the size of the image defect. In the embodiment, the region to be cut out was made to be rectangular, but the present invention is not limited thereto. For example, the shape may be a free shape including a circle, a similar shape, or the like.

### Second Embodiment

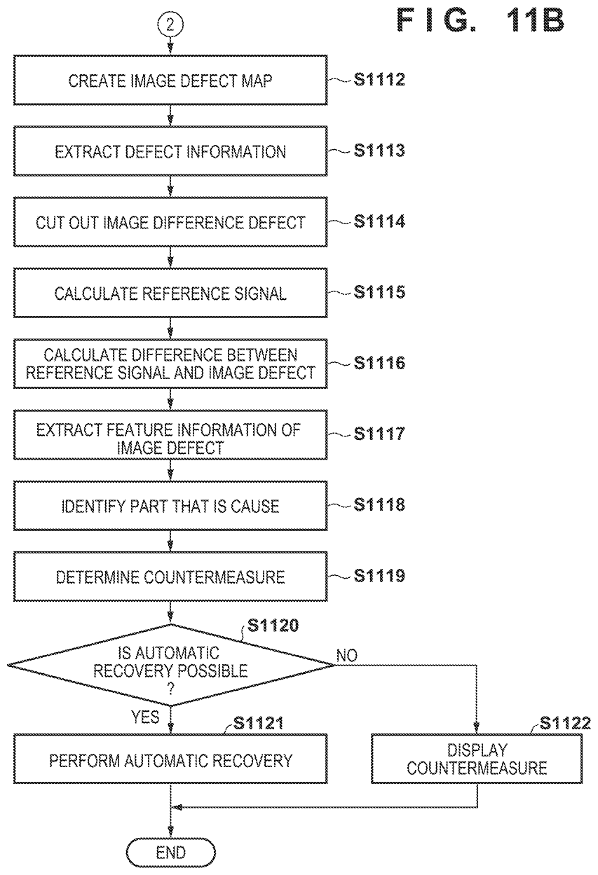

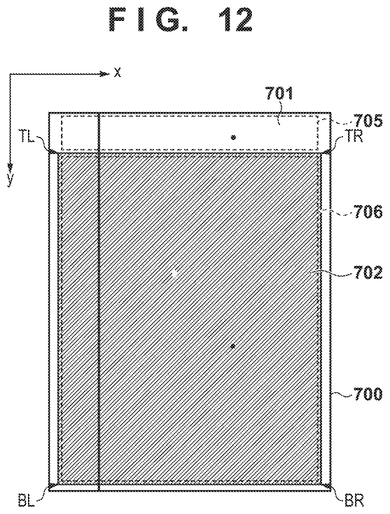

Next, an image forming apparatus according to a second embodiment of the present invention will be described with reference to FIGS. 11A and 11B and FIG. 12. In the first embodiment described above, when checking whether or not there is an image defect in read image of the test chart, a reference image of the test chart is created, and the presence or absence of an image defect is determined by the processing for comparison the reference image and the read image. In contrast, in the second embodiment, when checking whether or not there is an image defect in read image of the test chart, a reference signal is calculated from the read image without creating the reference image of the test chart, and the presence or absence of the image defect is determined from the reference signal and the read image. Since the configuration of the print system and the like is similar to that of the first embodiment, description thereof will be omitted.

FIGS. 11A and 11B are flowcharts for describing a procedure of image diagnosis processing performed by the external controller 102 and the print system 101 according to according to the second embodiment.

In step S1101, image diagnosis control is started when an instruction for image diagnosis is given by a user or a serviceman from the UI display unit 241 that also serves as an operating unit. First, in step S1102, the CPU 251 of the external controller 102 transmits the rasterized bitmap data from the video I/F 258 through the video cable 106 to the video I/F 205 of the printing apparatus 107. The CPU 206 of the printing apparatus 107, after having received the bitmap data in this way, prints the test chart 700 using the bitmap data with the printing unit 203. The test chart 700 according to the second embodiment includes the non-image area 701 arranged on the leading edge side of the chart as shown in FIG. 7 and the intermediate tone image area 702, as in the first embodiment, and in the intermediate tone image area 702 of the test chart, an image is formed using yellow (Y), magenta (M), cyan (C), and black (K) toners.

In step S1103, the CPU 214 of the inspection apparatus 109 reads the printed test chart by the image readers 331 and 332, and stores the results in the HDD 216 of the inspection apparatus 109 as inspection target images in step S1104. The resolution at the time of reading the printed test chart by the image readers 331 and 332 will be described hereinafter as 600 dpi in the second embodiment.

Next, the processing proceeds to step S1105, and the CPU 214 executes moiré suppression filter processing on the read images of the printed material obtained by the image readers 331 and 332. Next, the processing proceeds to step S1106, and the CPU 214 converts the resolution of the read images into 300 dpi. Next, the processing proceeds to step S1107, the CPU 214 performs a gamma correction by using a look-up table stored in the memory 215 of the inspection apparatus 109 so as correct non-linearity in the gradation of the read images. Next, the processing proceeds to step S1108, and the CPU 214 calculates a reference signal for detecting an image defect.

FIG. 12 is a diagram for describing a reference region when calculating a reference signal for detecting an image defect in the second embodiment.

First, the positions of the four corners (TL, TR, BL, BR) of the intermediate tone image area 702 with respect to the recording material are obtained from the read images stored in step S1104. Next, a reference region 705 for obtaining a reference signal of the non-image area 701 from the positions of the four corners of the intermediate tone image area 702 and a reference region 706 for obtaining a reference signal of the intermediate tone image area 702 are determined. Then, an average value of RGB signal values of pixels of the read image in the reference region 705 is calculated to be the reference signal of the non-image area 701, and the average value of RGB signal values of pixels of the read image in the reference region 706 is calculated to be the reference signal of the intermediate tone image area 702.

The reference regions 705 and 706 are set as follows. At the timing of the calculation of the reference signal in step S1108 in the image diagnosis processing, the presence or absence of image defects in the test chart 700 and the positions at which the image defects occur are not known, and there is a possibility that density unevenness is present in a toner image in the intermediate tone image area 702. Therefore, a reference region for calculating a reference signal is set to be a wide region, so that the influence of image defects and density unevenness is reduced. In the second embodiment, the position of the reference region 705 of the non-image area 701 in the x direction which is perpendicular to the conveyance direction of the test chart is set to be 1 mm to the inside from the x coordinates of the upper left corner TL and the upper right corner TR of the intermediate tone image area 702. In addition, the position of the reference region 705 in the conveyance direction y of the test chart is set to be 1 mm to the inside from the leading edge of the test chart 700 and from the y coordinate of the upper left corner TL and the upper right corner TR of the intermediate tone image area 702. In addition, as the position of the reference region 706 of the intermediate tone image area 702, the position is set to be 1 mm to the inside from the positions of the four corners (TL, TR, BL, BR) of the intermediate tone image area 702.

Next, the processing proceeds to step S1109, and the CPU 214 performs difference calculation processing on the reference signals of the non-image area 701 and the intermediate tone image area 702 calculated in step S1108 and RGB signal values of the respective read image pixels stored in step S1104. When the difference calculation processing is completed, the processing proceeds to step S1110, and the CPU 214 determines whether or not the printed test chart is normal as a result of the calculation of the difference between the reference signals and the read image in the same manner as the inspection processing described above. If it is determined that the printed test chart image is normal, the processing advances from step S1111 to step S1110, and the CPU 214 displays an image diagnosis result indicating that there is no problem on the UI display unit 241 of the inspection apparatus 109.

Meanwhile, the processing advances from step S1110 to step S1112 in a case where it determines that the printed test chart is not normal (there is a defect in an image). In step S1112, the CPU 214 creates an image defect map and extracts defect information from the image defect map in step S1113 as in the first embodiment. Next, the processing proceeds to step S1114, and the CPU 214 cuts out an image defect from a read image based on the defect information extracted in step S1113.

Next, the processing proceeds to step S1115, and the CPU 214 calculates a reference signal to be used in later processing. This reference signal is calculated from an average value of RGB signal values of pixels of a rectangular region in the vicinity of an image defect and excluding the image defect, as in the first embodiment. Next, the processing proceeds to step S1116, and the CPU 214 performs difference calculation processing on the reference signal calculated in step S1115 and RGB signal values of the pixels of the image defect cut out in step S1114. Next, the processing proceeds to step S1117, and the CPU 214 extracts feature information of the image defect based on difference data obtained by the difference calculation of step S1116. The feature information includes color information such as whether it is single color-yellow, magenta, cyan, or black- or multi-order color occurring in a plurality of colors; contrast information indicating the density of the image defect; and shape information such as a size and a vertical length. Further, coordinate information may be a position in the x direction perpendicular to the conveyance direction of the test chart in the printing apparatus 107; periodicity information as to when defects having similar features in the y direction which is parallel to the conveyance direction of the test chart in the printing apparatus 107 periodically occur; and the like.

Next, the processing proceeds to step S1118, and the CPU 214 identifies the cause of the image defect obtained in step S1117 in the printing apparatus 107 and the inspection apparatus 109 based on the feature information of the image defect. Next, the processing proceeds to step S1119, and the CPU 214 determines a countermeasure for the image defect based on the cause identified in step S1118. Examples of types of countermeasures include cleaning of the image reading surface of the image readers 331 and/or 332 of the inspection apparatus 109 to remove dirt, having a user handle adjustment of a recording material, and the like, and having a service person handle a part replacement or the like. In addition, the printing apparatus 107 can automatically recover from a defect by cleaning a wire or grid of a corona charger, which is a charging unit of a photosensitive drum provided in image forming stations 304 to 307 of the printing apparatus 107, or the like. In addition, there is no need for a countermeasure when the cause of the image defect is fibers or foreign matter that got into the recording material prior to image formation being performed.

Next, the processing proceeds to step S1120, and the CPU 214 determines whether automatic recovery is possible by the countermeasure determined in step S1119. The processing proceeds to step S1121 when it is determined that automatic recovery by the countermeasure is possible, the CPU 214 performs automatic recovery control corresponding to the cause of the image defect, and ends the processing. Meanwhile, if it determined that automatic recovery is not possible by the countermeasure, the processing proceeds to step S1122, and the CPU 214 displays the image diagnosis result and the countermeasure therefor on the UI display unit 241 of the inspection apparatus 109, and ends the image diagnosis processing.

As described above, according to the second embodiment, when an image defect is detected, a reference signal for detecting an image defect is calculated from a wide region of a non-image area and an intermediate tone image area of the test chart, and the image defect is detected from a difference between the reference signal and the read image. Then, when a feature of the image defect is extracted, a reference signal for feature extraction is calculated from a rectangular region in the vicinity of the image defect and excluding the image defect, and feature information of the image defect is extracted from the difference between the reference signal and the read image.

Then, image diagnosis processing for identifying a cause of an image defect from the feature information of the image defect is executed when an image defect is detected in the defect inspection processing and when an increase in the frequency thereof is observed. As a result, it is possible to recover the operation of the printing apparatus at an early stage by reliably identifying a cause of an image defect and performing a countermeasure therefor.

Also, by executing such image diagnosis processing before the user starts printing, it is possible to reliably discover an image defect and to guarantee that there is no problem in the printing apparatus. Thereby, it is possible to prevent the generation of a printed material including an image defect.

Further, since the image diagnosis processing is performed only using the read images obtained by the image readers without using a reference image of the test chart, processing for condition adjustment and the alignment of the reference image and the read image, as performed in the first embodiment, is unnecessary, and so image diagnosis processing can be performed with a simpler configuration. Also, in the second embodiment, the region for calculating the reference signal is made to be rectangular, but the present invention is not limited thereto. For example, the shape may be a free shape including a circle, a similar shape, or the like.

### OTHER EMBODIMENTS

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

What is claimed is:

1. A print system comprising a printing apparatus and an inspection apparatus,
wherein the printing apparatus generates a printed material based on print data,
and the inspection apparatus, the print system comprising:
one or more controllers including one or more processors and one or more memories, the one or more controllers configured:
to obtain a read image by reading the printed material;
to detect an image defect that has occurred in the printed material by comparing the read image and a reference image;
to extract feature information of the image defect based on difference information between pixel data of the reference image corresponding to a plurality of pixels in a region surrounding the image defect excluding the image defect in the region and pixel data indicating the image defect included in the read image; and
to identify a cause of the image defect based on the extracted feature information.

2. The print system according to claim 1, wherein the pixel data of the reference image includes an average value of RGB signal values of the plurality of pixels in the region surrounding the image defect excluding the image defect in the region.

3. The print system according to claim 1, wherein the region surrounding the image defect is a region having sides that are apart from at least upper, lower, left, and right edge portions of the image defect by a predetermined length.

4. The print system according to claim 1, wherein the cause of the image defect is due to either of the printing apparatus and the inspection apparatus.

5. The print system according to claim 1, wherein the printed material is a test chart including an image of a plurality of colors.

6. The print system according to claim 5, wherein, in the detection of the image defect, the one or more controllers detect an image defect that has occurred in the printed material based on difference information between the reference image generated from the print data and the read image.

7. The print system according to claim 5, wherein, in the detection of the image defect, the image defect is detected based on difference information between the reference image obtained by reading the test chart and the read image.

8. The print system according to claim 7, wherein the test chart includes an image area and a non-image area, and
the pixel data of the reference image is obtained from an average value of RGB signal values of pixels of read image, obtained by reading the test chart, corresponding to each of the image area and the non-image area.

9. An inspection apparatus for receiving and inspecting a printed material that has been printed on a printing apparatus, the inspection apparatus comprising:
a reader; and
one or more controllers including one or more processors and one or more memories, the one or more controllers configured:
to obtain a read image by reading the printed material by using the reader;
to detect an image defect that has occurred in the printed material by comparing the read image and a reference image;
to extract feature information of the image defect based on difference information between pixel data of the reference image corresponding to a plurality of pixels in a region surrounding the image defect and excluding the image defect in the region and pixel data indicating the image defect included in the read image; and
to identify a cause of the image defect based on the extracted feature information.

10. The inspection apparatus according to claim 9, wherein the pixel data of the reference image includes an average value of RGB signal values of the plurality of pixels in the region surrounding the image defect excluding the image defect in the region.

11. The inspection apparatus according to claim 9, wherein the region surrounding the image defect is a rectangle having sides that are away from at least upper, lower, left, and right edge portions of the image defect by a predetermined length.

12. The inspection apparatus according to claim 9, wherein the cause of the image defect is due to either of the printing apparatus and the inspection apparatus.

13. The inspection apparatus according to claim 9, wherein the printed material is a test chart including an image of a plurality of colors.

14. The inspection apparatus according to claim 13, wherein, in the detection of the image defect, the one or more controllers detects an image defect that has occurred in the printed material based on difference information between the reference image generated from print data based upon which the test chart is printed and the read image.

15. The inspection apparatus according to claim 13, wherein, in the detection of the image defect, the image defect is detected based on difference information between the reference image obtained by reading the test chart with the reader and the read image.

16. The inspection apparatus according to claim 15, wherein the test chart includes an image area and a non-image area, and
the pixel data of the reference image is obtained from an average value of RGB signal values of pixels of read image, obtained by reading the test chart, corresponding to each of the image area and the non-image area.

17. A method of controlling an inspection apparatus for receiving and inspecting a printed material that has been printed by a printing apparatus, the method comprising:
obtaining a read image by reading the printed material;
detecting an image defect that has occurred in the printed material by comparing the read image and a reference image;
extracting feature information of the image defect based on difference information between pixel data of the reference image corresponding to a plurality of pixels in a region surrounding the image defect excluding the image defect in the region and pixel data indicating the image defect included in the read image; and
identifying a cause of the image defect based on the extracted feature information.

18. A non-transitory computer-readable storage medium storing a program for causing a processor to execute a method of controlling an inspection apparatus for receiving and inspecting a printed material that has been printed by a printing apparatus, the method comprising:
obtaining a read image by reading the printed material;
detecting an image defect that has occurred in the printed material by comparing the read image and a reference image;
extracting feature information of the image defect based on difference information between pixel data of the reference image corresponding to a plurality of pixels in a region surrounding the image defect excluding the image defect in the region and pixel data indicating the image defect included in the read image; and
identifying a cause of the image defect based on the extracted feature information.
